(19) United States
(12) Patent Application Publication
(10) Pub. No.: US 2024/0423364 A1
(43) Pub. Date: Dec. 26, 2024

(54) All-In-One Kitchen Systems

(71) Applicants: Eddie Dorszynski, San Diego, CA (US); Harrison McCarey, San Diego, CA (US); Brandon Wood-Fisher, Madrid, IA (US); Taylor Dorszynski, San Diego, CA (US)

(72) Inventors: Eddie Dorszynski, San Diego, CA (US); Harrison McCarey, San Diego, CA (US); Brandon Wood-Fisher, Madrid, IA (US); Taylor Dorszynski, San Diego, CA (US)

(21) Appl. No.: 18/736,380

(22) Filed: Jun. 6, 2024

Related U.S. Application Data
(60) Provisional application No. 63/471,494, filed on Jun. 6, 2023.

(51) Int. Cl. A47B 77/08; A47B 77/06; B60N 3/10

(52) U.S. Cl. CPC A47B 77/08; A47B 77/06; B60N 3/104

(57) ABSTRACT

An all-in-one kitchen system including: a cabinet enclosure having a body with insulation; a cooking/prep area; a hot water and shower assembly; a sink with a detachable/storable shower head; a refrigerator; a stove; and a powering means with optional solar charging capability. The body of the cabinet enclosure provides mounting for the cooking/prep area, the insulation, and removably houses the hot water and shower assembly, the sink with the detachable/storable shower head, the refrigerator, the stove; and the powering means in combination. It may have a plumbing wall and a foldaway shower pan and drain system. As designed the all-in-one kitchen system is configured for portable use and occupies a minimum footprint.

### CROSS-REFERENCE TO RELATED APPLICATION

The present application is related to and claims priority from prior provisional application Ser. No. 63/471,494, filed Jun. 6, 2023 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71 (d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

1. The present invention relates generally to the field of appliances and more specifically relates to refrigerator appliances.

### 2. DESCRIPTION OF THE RELATED ART

Refrigeration is modernly used to preserve food and beverages at a sufficiently cool temperature. Refrigerators conventionally are an insulated compartment that use a heat pump to transfer heat out and keep the contents and environment within the refrigerator cool. Some refrigerators have freezer compartments that are kept at a temperature below freezing and the remainder of the fridge is kept above freezing. Refrigerators may be found in recreational vehicles (RV). RV fridges generally work without a compressor or other moving parts. Propane or electric power may be used to heat the refrigerant in RV models. Room within RVs is very limited. A suitable solution is desired.

Various attempts have been made to solve the above-mentioned problems such as those found in U.S. Pat. No. 3,627,396 to Lester D. Miller. This art is representative of cabinets for campers. None of the above inventions and patents, taken either singly or in combination, is seen to describe the invention as claimed.

Ideally, a kitchen should provide appliances that function efficiently and, yet would operate reliably and be manufactured at a modest expense. Thus, a need exists for a reliable all-in-one kitchen system to avoid the above-mentioned problems.

### BRIEF SUMMARY OF THE INVENTION

In view of the foregoing disadvantages inherent in the known refrigerator art, the present invention provides a novel all-in-one kitchen system. The general purpose of the present invention, which will be described subsequently in greater detail is to provide an effective and efficient all-in-one kitchen system which is multi-functional in use and occupies a small footprint. Preferred embodiments are for use in and out of RVs and van conversions.

An all-in-one kitchen system is disclosed herein comprising: a cabinet enclosure having a body (shell) with insulation; a cooking/prep area; a hot water and shower assembly; a foldaway shower pan and drain system: a separate shower hot water mixing valve and compartment; a sink preferably with a detachable/storable shower head for indoor or outdoor use; a refrigerator; a stove; and a lithium iron/lithium iron phosphate powering means. The ability to consolidate the key plumbing components i.e. water pump, pressure accumulator, supply pressure lines, return lines, etc. are a unique feature to the all-in-one-kitchen (AIOK) and allow efficient shipping, assembly, disassembly and maintenance. The system comprises a removable plumbing wall, battery/power system with optional solar charging capability that can be connected to a rechargeable mobile power system or stand alone power supply.

The body of the cabinet enclosure provides mounting for the cooking/prep area, the insulation, and removably houses the hot water and shower assembly, the built in fold down/fold away shower pan and internal drain system, the sink with the detachable/storable shower head, the refrigerator, the stove; and the lithium iron/lithium iron phosphate battery connection in combination. As designed the all-in-one kitchen system is configured for portable use. The refrigerator may comprise drawers. The stove may comprise burners and/or a surface plate. The current invention has a unique “Mounting cradle” allowing for efficient and extremely secure mountability and removability. The system is installable in van conversions and rvs and may be removed for outside use. Further, it is capable of stand alone outdoor use by using only either the vehicle's power system or another remote power supply.

A kit is also disclosed herein including: the cabinet enclosure; the insulation; the cooking/prep area; the hot water and shower assembly, the built in hinged down shower pan and internal drain system, a separate shower hot water mixing valve and compartment, the sink with the detachable/storable shower head; the refrigerator; the stove; and the lithium iron/lithium iron phosphate battery with optional solar charging capability. Certain kits may not include appliance(s), connections, valves and the like. The kit is able to be shipped efficiently via flat pack and ship and is suitable for installation by licensed installers or by the do-it-yourselfer. The power system, refrigerator and other components may be shipped directly from the supplier.

A method of monetizing an all-in-one kitchen system is also disclosed herein comprising the steps of: providing an all-in-one kitchen system; selling the all-in-one kitchen system as a flat, pack and ship kit; shipping the all-in-one kitchen system as a flat, pack and ship kit; and installing the all-in-one kitchen system; wherein the step of installing comprises removable installation in a vehicle and alternately the system can be installed in non-vehicle applications. The all in one kitchen assembly is capable of stand alone outdoor use by using only either the vehicles power system or another remote power supply.

The present invention holds significant improvements and serves as an all-in-one kitchen system. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, all-in-one kitchen systems, constructed and operative according to the teachings of the present invention.

FIG. 1 shows a perspective view illustrating an all-in-one kitchen system according to an embodiment of the present invention.

FIG. 2 is a perspective view illustrating the all-in-one kitchen system according to an embodiment of the present invention of FIG. 1.

FIG. 3 is a perspective view illustrating the all-in-one kitchen system according to an embodiment of the present invention of FIG. 1.

FIG. 4 is a perspective view illustrating the all-in-one kitchen system according to an embodiment of the present invention of FIG. 1.

FIG. 5 is a flowchart illustrating a method of monetizing the all-in-one kitchen system according to an embodiment of the present invention of FIGS. 1-4.

The various embodiments of the present invention will hereinafter be described in conjunction with the appended drawings, wherein like designations denote like elements.

### DETAILED DESCRIPTION

As discussed above, embodiments of the present invention relate to a refrigerator and more particularly to an all-in-one kitchen system as used to improve the efficiency and useful footprint inside RVs.

Generally speaking, the self-contained all-in-one kitchen, hot water & shower unit comprises the kitchen cabinet This self-contained all-in-one kitchen, hot water and shower unit with water resistant cabinet assembly includes the following: optionally the system may use propane, but preferably we find advantage by it exclusively using clean renewable energy.

A hot and cold pressurized running water sink and shower water system is also provided. The propane powered hot water heater is preferably encased within a ventilated, heat resistant and insulated case with heat range adjustable control settings with extremely low or zero emission output. Options of 16 to 25 gallons of fresh and gray (waste) water storage tanks may be employed. The fresh water tank is food grade approved and the tanks are removable, if cleaning or maintenance is needed. A stainless steel sink with detachable/storable shower head is also included. The shower head handle has a control valve built in to control waterflow, high quality faucet mixing valve and has a flexible and storable shower extension hose. It can be connected to a rechargeable mobile power system or stand alone power supply provided with optional solar charging capabilities may be mounted inside or outside of the protective enclosure. A 12 volt water pump with auto pressure sensing and auto shutoff is included as well as a water pressure accumulator tank. The frame of this unit is preferably comprised of waterproof aluminum framework and encased in exotic and water resistant wood, laminate, composite or the like. A toe kick can may provided for comfortable operation and use.

The monitoring and control system panel is mounted into the most convenient access point of the exterior wood panel (or remotely) and is intentionally designed and engineered for simplicity of data viewing and controls operation. The control panel may comprise a phone app for example if desired. The entire frame (internal and external) is preferably composed of precisely cut, drilled and precision machined extruded t-slot aluminum (rustproof, waterproof, and corrosion resistant) rails. The vast majority of mounting, connecting and related hardware(s) is made from high-quality stainless steel with similar corrosion and waterproof properties. The wood, laminate or composite materials used comprises precision cut and milled panels.

The self-contained all-in-one kitchen and hot shower with fold away shower pan with water resistant cabinet assembly is engineered and designed to be used indoors or outdoors and is portable. It not only can be a stand-alone unit with all the necessary power sources battery, propane and power connections and optional solar power, it can also be connected to external power and fuel sources if equipped or preferred. Additionally, it is designed for do it yourself (DIY) assembly and is designed to be safely flat packed and shipped to customers anywhere in the world. Propane (if used) and any fuels and containers used should be used in compliance with local laws.

Being standalone, the all in one kitchen & hot water shower unit does not require any external connections (although it does support them) allowing it to be used in a very wide range of applications i.e. conversion vans, RV's, toy haulers, remote cabins, man caves, decks and patios, tiny homes, etc. The cabinet's “internals” are designed and constructed to allow the do it yourself customer ease of connections and assembly. All interior water and plumbing connections are preferably made with stainless steel flexible hose and are connected using standard water hose ‘type’ connections. The ability to consolidate the key plumbing components i.e. water pump, pressure accumulator, supply pressure lines, return lines, etc. are a unique feature to the AIOK and allow efficient shipping, assembly, disassembly and maintenance, referred to as the removable plumbing wall.

The effectively water proof cabinet is engineered into three unique partitions/sections in preferred embodiments, each serving its own specific purpose. These sections make for ease of assembly as well as provide added safety by separating the heat source from the fuel and battery power source while protecting the water supply, plumbing and refrigeration from the other two compartments of the cabinet and other interior components. The first partition, plumbing, is the partition that holds the water tanks, and the majority of the plumbing hardware and connections. Located on the outside of the partition are two water inlets. One gravity fresh water fill port as well as the threaded hose bib pressure filler inlet. The gravity fill feeds directly into the fresh water tank, while the pressured line feeds directly into the system and can be used in place of the electric pump if so desired. Located near the fresh tank is the water pump with auto pressure sensing and auto shut off and the water pressure accumulator tank. Located adjacent to the freshwater tank is the grey waste water tank with a drain petcock used for draining and maintenance. The grey water tank has connections and the capacity so that the grey water can be recycled, filtered or other for use in washing feet and the like.

The system may comprise drop down shelf(s), spice shelf, lights, dropdown picnic table, exterior fold out table, fold down desk, laptop organizer shelf, handles & wheels, wheel locks, utensil hangers, and solar panel flip-up. Monoxide, smoke and propane alarms may be included.

If propane equipped, also located in this compartment is the propane supply tank area (tank not supplied with unit for legal reasons), regulator and hose. Several size options will be available for customer specific needs and sizing requirements. The portable and refillable propane tanks are widely available and very cost effective such as those used for BBQ grills. The propane tank storage area is designed to make the tank removable as well as securely mounted inside of this first partition.

The second partition provides space, insulation and ventilation for the refrigeration system. Optional cooling fans and ventilation can be added for hot weather climates. Several different sizes of 2 and 3 way refrigerators may be available for customer specific needs and sizing requirements.

The third partition houses the hot water heating system providing for sufficient heat and exhaust dissipation. The heat and volume controls for the hot water heater are preferably located on the exterior of this portion of the cabinet for periodic adjustments. An upward ventilation system exhausts the heat from the heating unit as well as provides some comfort on cool or cold days. Optional ventilation designs are available for custom orders for customer specific needs and specific design requirements.

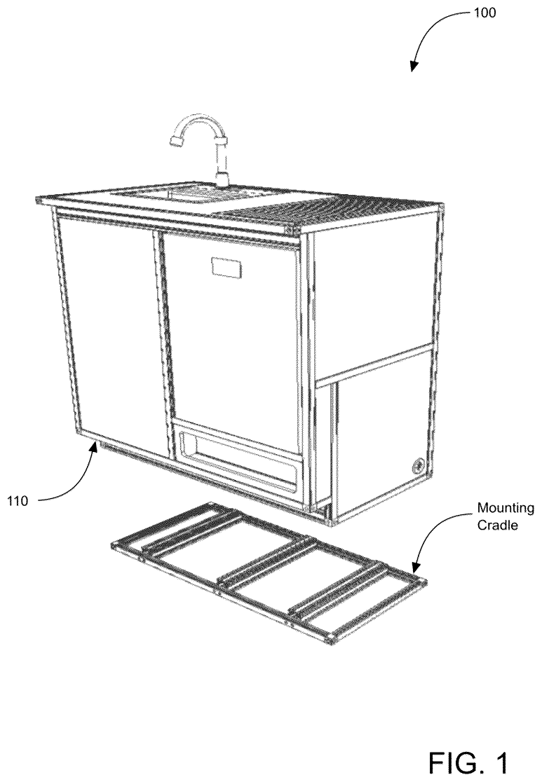

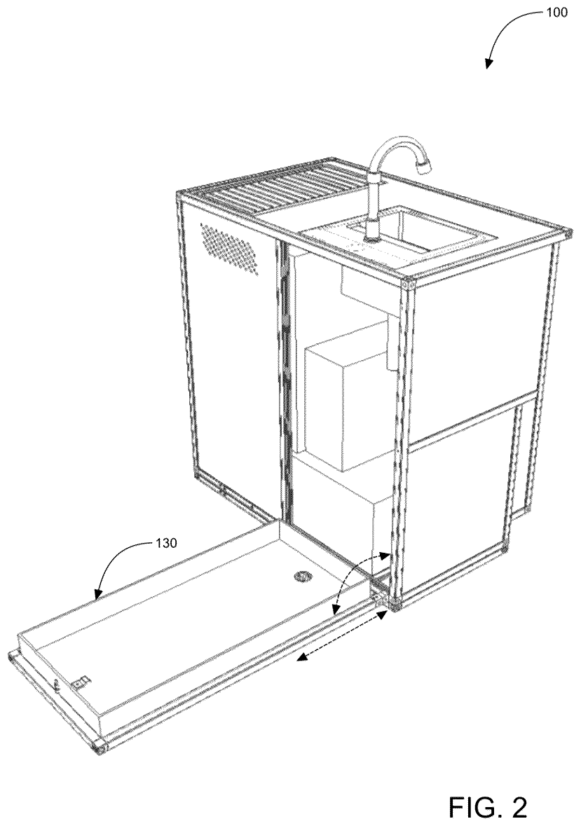

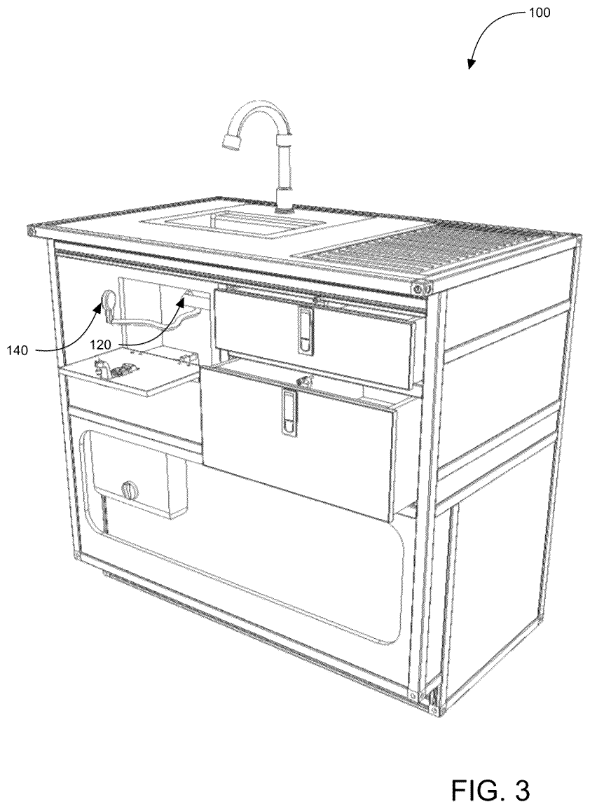

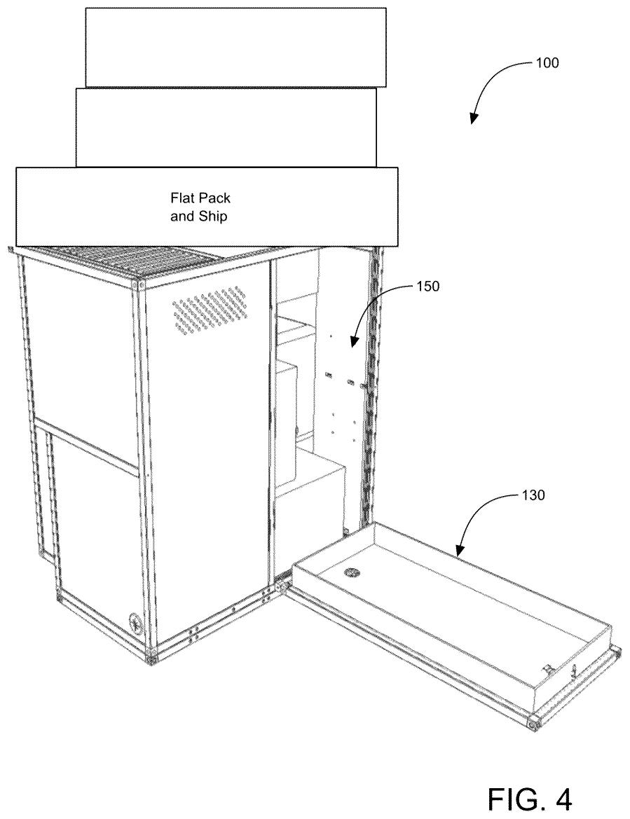

Referring to the drawings there is shown in FIGS. 1-4, various views of the all-in-one kitchen system 100 comprising: a cabinet enclosure 110 having a body (shell) with insulation; a cooking/prep area; a hot water and shower assembly 120; the built in fold down/fold away shower pan 130 and internal drain system, a separate shower hot water mixing valve and compartment, a sink with a detachable/storable shower head 140; a refrigerator; a stove; and a mobile power supply system with optional solar charging capability. The body of the cabinet enclosure 110 provides mounting for the cooking/prep area, the insulation, and removably houses the hot water and shower assembly, the sink with the detachable/storable shower head 140, the refrigerator, the stove; and the powering means in combination. As designed the all-in-one kitchen system 100 is configured for portable use. The all-in-one kitchen system 100 is (removably) mountable within a vehicle-body of a vehicle such as a van or other. The all in one kitchen assembly is capable of stand alone outdoor use by using only either the vehicles power system or another remote power supply.

The shower head handle has a control valve built in to control waterflow, a high quality faucet mixing valve and flexible and a storable shower extension hose. The cabinet enclosure 110 comprises a frame and preferably water resistant wood; wherein the cabinet enclosure 110 is effectively waterproof. A monitoring and control system panel may be used and may be in communication with the host vehicle and/or an electronic device. The all-in-one kitchen system 100 may further comprise fresh and gray water storage tanks. The all-in-one kitchen system 100 also preferably further comprises connection means for external power and fuel sources.

The cabinet enclosure 110 in preferred embodiments comprises three sections, each of the sections make for ease of assembly as well as provide a safety factor by separating any heat source from the fuel and the battery (powering means) while protecting via isolating heat and fuel from the water supply, plumbing and refrigeration. Interior water and plumbing connections comprising stainless steel flexible hose which are connected using standard water hose type connections are also preferably included. One of the three sections comprises a plumbing partition with at least two water inlets; wherein the at least two water inlets comprise a gravity fresh water fill port and a threaded hose bib pressure filler inlet. The ability to consolidate the key plumbing components i.e. water pump, pressure accumulator, supply pressure lines, return lines, etc. are a unique feature to the AIOK and allow efficient shipping, assembly, disassembly and maintenance. Here it is referred to as the removable plumbing wall 150.

Another one of the three sections comprises a second refrigeration partition which provides space, insulation and ventilation for the refrigerator. The refrigerator may be optionally a 2 or 3 way (propane, 12 volt or 110 volt) refrigerator. Some may comprise freezer compartments.

Another one of the three sections comprises a third partition which houses a hot water heating system providing for sufficient heat and exhaust dissipation. The heat and volume controls for a hot water heater of the hot water heating system are preferably located on an exterior of the cabinet enclosure 110 for periodic adjustments. An upward ventilation system is used to exhaust heat from the hot water heater as well as provides comfort on cool days. The cabinet enclosure 110 may be configured to further comprise a fuel container during an in-use condition.

All-in-one kitchen system 100 may be sold as kit comprising the following parts: at least one the cabinet enclosure 110; the insulation; the cooking/prep area; the hot water and shower assembly 120; the built in fold down/fold away shower pan 130 and internal drain system, a separate shower hot water mixing valve and compartment, the sink with the detachable/storable shower head 140; the refrigerator; the stove; and the lithium iron/lithium iron phosphate battery power system with optional solar charging capability; and at least one set of user instructions. The kit has instructions such that functional relationships are detailed in relation to the structure of the invention (such that the invention can be used, maintained, or the like in a preferred manner). Certain kits may not include appliances, connections and the like. The all-in-one kitchen system 100 may be manufactured and provided for sale in a wide variety of sizes and shapes for a wide assortment of applications. Upon reading this specification, it should be appreciated that, under appropriate circumstances, considering such issues as design preference, user preferences, marketing preferences, cost, structural requirements, available materials, technological advances, etc., other kit contents or arrangements such as, for example, including more or less components, customized parts, different powering combinations, parts may be sold separately, etc., may be sufficient.

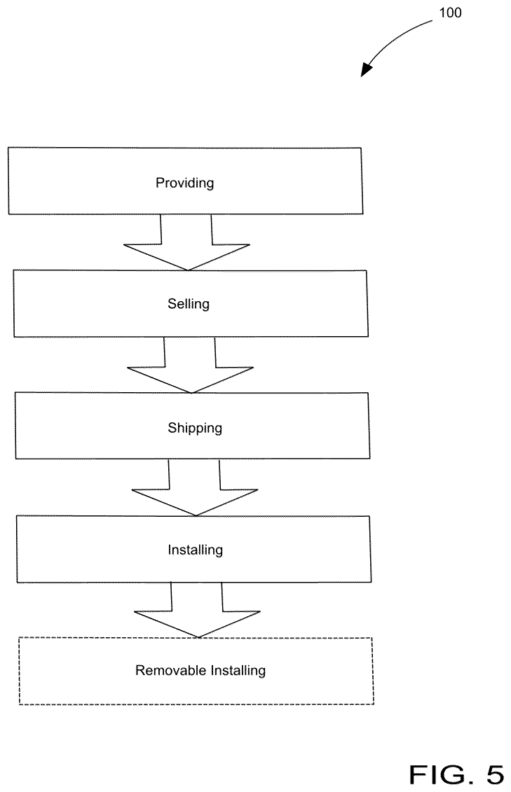

Referring now to FIG. 5, showing a method of monetizing an all-in-one kitchen system 100 comprising the steps of: providing an all-in-one kitchen system 100; selling the all-in-one kitchen system 100 as a flat, pack and ship kit; shipping the all-in-one kitchen system 100 as a flat, pack and ship kit; and installing the all-in-one kitchen system 100; wherein the step of installing comprises removable installation in a vehicle and alternately the system 100 can be installed in non-vehicle applications. Optional steps of the method are illustrated using dotted lines in FIG. 5 so as to distinguish them from the other steps of the method.

It should be noted that the steps described in the method of use can be carried out in many different orders according to user preference. The use of “step of” should not be interpreted as “step for”, in the claims herein and is not intended to invoke the provisions of 35 U.S.C. § 112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. An all-in-one kitchen system comprising:
a cabinet enclosure having a body with insulation; and
a cooking/prep area;
a hot water and shower assembly;
a sink with a detachable/storable shower head;
a refrigerator;
a stove; and
a mobile power supply system, a lithium iron/lithium iron phosphate powering means, with optional solar charging capability;
wherein said body of said cabinet enclosure provides mounting for said cooking/prep area, said insulation, and removably houses said hot water and shower assembly, said sink with said detachable/storable shower head, said refrigerator, said stove; and said mobile power supply system; and
wherein said all-in-one kitchen system is configured for self-sufficient portable use.

2. The all-in-one kitchen system of claim 1 wherein said all-in-one kitchen system is removably mountable within a vehicle-body of a vehicle.

3. The all-in-one kitchen system of claim 1 wherein said shower head handle has a control valve built in to control waterflow, high quality faucet mixing valve and flexible and storable shower extension hose and a foldaway shower pan and drain system.

4. The all-in-one kitchen system of claim 1 wherein said cabinet enclosure comprises a separate shower hot water mixing valve and compartment.

5. The all-in-one kitchen system of claim 1 further comprising a monitoring and control system panel.

6. The all-in-one kitchen system of claim 1 further comprising fresh and grey water storage tanks.

7. The all-in-one kitchen system of claim 1 further comprising connection means for external power, water, and fuel sources via a plumbing wall.

8. The all-in-one kitchen system of claim 1 wherein said cabinet enclosure comprises three sections, each of said sections make for ease of assembly as well as provide a safety factor by separating a heat source from fuel and battery while protecting via isolating from water supply, plumbing and refrigeration.

9. The all-in-one kitchen system of claim 8 further comprising interior water and plumbing connections comprising stainless steel flexible hose which are connected using standard water hose type connections.

10. The all-in-one kitchen system of claim 8 wherein one of said three sections comprises a plumbing partition with at least two water inlets.

11. The all-in-one kitchen system of claim 10 wherein said at least two water inlets comprise a gravity fresh water fill port and a threaded hose bib pressure filler inlet.

12. The all-in-one kitchen system of claim 8 wherein one of said three sections comprises a second refrigeration partition which provides space, said insulation and ventilation for the refrigerator.

13. The all-in-one kitchen system of claim 8 wherein one of said three sections comprises a third partition which houses a hot water heating system providing for sufficient heat and exhaust dissipation.

14. The all-in-one kitchen system of claim 13 wherein heating temperature and volume controls for a hot water heater of the hot water heating system are located on an exterior of the cabinet enclosure for periodic adjustments.

15. The all-in-one kitchen system of claim 14 wherein an upward ventilation system which exhausts heat from the hot water heater as well as provides heating capability for use to warm an environment.

16. The all-in-one kitchen system of claim 1 wherein said cabinet enclosure is configured to further comprise a fuel container during an in-use condition.

17. An all-in-one kitchen system comprising:
a cabinet enclosure having
a body with insulation; and
a cooking/prep area;
a hot water and shower assembly;
a sink with a detachable/storable shower head;
a refrigerator;
a stove;
a plumbing wall;
a foldaway shower pan and drain system; and
a mobile power supply system, a lithium iron/lithium iron phosphate powering means, with optional solar charging capability;
wherein said body of said cabinet enclosure provides mounting for said cooking/prep area, said insulation, and removably houses said hot water and shower assembly, said sink with said detachable/storable shower head, said refrigerator, said stove; and said mobile power supply system; and
wherein said all-in-one kitchen system is configured for self-sufficient portable use;
wherein said body of said cabinet enclosure provides mounting for said cooking/prep area, said insulation, and removably houses said hot water and shower assembly, said sink with said detachable/storable shower head, said refrigerator, said stove; and said powering means;
wherein said refrigerator is able to be operated via propane, 12 volt and alternately 110 volt;
wherein said stove is a propane-stove having at least 2 burners protected with a high temperature smoked glass overlay cover and stainless said steel cooking/prep area;
wherein said all-in-one kitchen system is mountable within a vehicle-body of a vehicle;
wherein a handle of said shower head has a control valve built in to control waterflow;
high quality faucet mixing valve and flexible and storable shower extension hose;
further comprising a monitoring and control system panel;
further comprising a fresh storage tank and a grey water storage tank with at least a capacity of 8 gallons;
wherein said fresh storage tank and said grey water storage tank are removable;
wherein said fresh storage tank is food grade approved for holding potable water;
further comprising connection means for external power and fuel sources;
wherein said cabinet enclosure comprises three sections, each of said sections make for ease of assembly as well as provide a safety factor by separating a heat source from fuel and powering means while protecting via isolating from water supply, plumbing and refrigeration;
further comprising interior water and plumbing connections comprising stainless steel flexible hose which are connected using standard water hose type connections;
wherein one of said three sections comprises a plumbing partition with at least two water inlets;
wherein said at least two water inlets comprise a gravity fresh water fill port and a threaded hose bib pressure filler inlet;
wherein one of said three sections comprises a second refrigeration partition which provides space, said insulation and ventilation for the refrigerator;
wherein one of said three sections comprises a third partition which houses a hot water heating system providing for sufficient heat and exhaust dissipation;
wherein heat and volume controls for a hot water heater of the hot water heating system are located on an exterior of the cabinet enclosure for periodic adjustments;
wherein an upward ventilation system which exhausts heat from the hot water heater as well as provides comfort on cool days;
wherein said cabinet enclosure is configured to further comprise a fuel container during an in-use condition; and
wherein said all-in-one kitchen system is configured for portable use.

18. The all-in-one kitchen system of claim 17 further comprising a kit including:
said cabinet enclosure;
said insulation;
said cooking/prep area;
said hot water and shower assembly;
said sink with said detachable/storable shower head;
said refrigerator;
said stove; and
said deep cycle battery with optional solar charging capability.

19. A method of monetizing an all-in-one kitchen system comprising the steps of:
providing an all-in-one kitchen system;
selling said all-in-one kitchen system as a flat, pack and ship kit;
shipping said all-in-one kitchen system as a flat, pack and ship kit; and
installing said all-in-one kitchen system.

20. The method of claim 19 wherein said step of installing comprises removable installation in a vehicle.
